(19) United States
(12) Patent Application Publication
(10) Pub. No.: US 2018/0158172 A1
(43) Pub. Date: Jun. 7, 2018

(54) HEAD-UP DISPLAY

(71) Applicant: Continental Automotive GmbH, Hannover (DE)

(72) Inventors: Bernd Trageser, Hainburg (DE); Torsten Grohmann, Darmstadt (DE); Jesko Schwarzer, Bonn (DE)

(21) Appl. No.: 15/820,097

(22) Filed: Nov. 21, 2017

(30) Foreign Application Priority Data
Dec. 5, 2016 (DE) 10 2016 224 166.4

(51) Int. Cl. G06T 3/00; G09G 3/00; G09G 5/10; G06F 3/01; B60K 35/00; G02B 27/01

(52) U.S. Cl. CPC G06T 3/0093; G09G 3/001; G09G 5/10; G06F 3/013; B60K 35/00; G02B 27/0101; G02B 2027/014; G09G 2380/10; B60K 2350/2052; B60K 2350/2008; B60K 2350/2069; G02B 2027/0138; G09G 2360/08

(57) ABSTRACT

The present disclosure relates to a head-up display with image distortion for a vehicle, which has an image signal source, an image distorter, a display unit and a mirror unit. According to the disclosure, the image signal source has a common output for image signals and configuration information, and the image distorter has a common input for image signals and configuration information.

### BRIEF DESCRIPTION OF THE DRAWINGS

FIG. 1 depicts an exemplary head-up display.

FIG. 2 depicts an exemplary circuit arrangement.

FIG. 3 depicts an exemplary image distorter.

FIG. 4 depicts an example of image distortion.

FIG. 5 depicts an exemplary signal.

FIG. 6 depicts a flowchart of an exemplary method according to the disclosure.

FIG. 7 depicts a flowchart of an exemplary method according to the disclosure.

### DETAILED DESCRIPTION

The present disclosure relates to a head-up display with image distortion for a vehicle. In this case, information for a viewer, for example the vehicle driver or another occupant of the vehicle, is directed into the eye of said viewer in a manner reflected via the windshield.

To conform to uneven projection surfaces, as represented by the windshield, image distortion, what is known as warping, is usually used. This is accomplished using what are known as warping matrixes or warping parameter sets that describe the type of the distortion. This matrix or these warping parameter sets is/are then normally applied to the actual image data in graphics computers, so that they are output in distorted form and, via the inverse distortion of the projection surface, are then depicted thereon in the originally desired form. Since the application of the warping matrix to the image data frequently requires a high level of computation power, but this step can easily be separated from the graphics data generation, it is possible to relocate the actual warping to a separate unit, which therefore greatly relieves the load on the graphics processing unit (GPU). In order to be able to use a separate unit of this kind as universally as possible, it needs to be provided not only with the image data but also with the actual configuration parameters, among other things the warping matrixes. Depending on the size of the warping matrixes and the number of interpolation points, greater bandwidths are sometimes required in this case, which require appropriate interfaces.

WO 2015/044716 discloses a head-up display having a separate warping unit that is provided with warping information from a separate memory unit. DE 20 2005 021 565 U1 also shows a head-up display having such a warping unit.

An improved head-up display, correspondingly improved methods for operating a head-up display and a corresponding signal are proposed.

A head-up display with image distortion for a vehicle according to the disclosure has an image signal source, an image distorter, a display unit and a mirror unit. In this case, the image signal source has a common output for image signals and configuration information, and the image distorter has a common input for image signals and configuration information. This has the advantage that a separate output or input is not required for the configuration information. It therefore becomes possible to save input and output pins on the image signal source and the image distorter. The image signal and configuration information are then transmitted interleaved in one another, and the capacity that is otherwise used only for the image transmission is additionally used, according to the disclosure, for transmitting configuration information. By way of example, the capacity is intended to be understood to mean the number of parallel lines and the data rate. In an embodiment, the configuration information is cleverly inserted into unused areas of the image data. The image signal source is used to provide an image to be depicted by the head-up display. The image distorter is used to distort the image to be displayed in conformity with the distortion of the mirror unit. In this case, the distortion produced by the image distorter compensates for that caused by the mirror unit. The display unit is used to display the distorted image. The mirror unit is used to combine the distorted image to be displayed with a background image and to direct the combined image into the eye of a viewer. The background image in the case of a vehicle is the surroundings visible through the windshield. The mirror unit is either the windshield itself or what is known as a combiner, a transparent and unilaterally half-silvered pane located between windshield and viewer. The configuration information is information for configuring the image distorter. In particular, this information is the aforementioned warping matrixes with information pertaining to the image distortion attuned to the mirror unit.

In an embodiment, the image distorter has one or more of the following units: a distortion unit for distorting the image to be depicted. An interpolation unit for interpolating pixels of a pixel array that are to be displayed on the display unit from interpolation points displaced relative to the array after the distortion. A memory unit for buffer-storing image signals and/or configuration information. A gamma correction unit for gamma correction of the pixels to be displayed on the display unit. A dithering unit for error diffusion, what is known as dithering, for the pixels to be displayed on the display unit. This has the advantage that single or multiple instances of said image conditioning functions are performed in one component. The image signal source does not need to be designed for the applicable functions. Advantageously, the distortion unit and the interpolation unit are combined.

Advantageously, the head-up display has multiple instances of said units, at least one of the units being able to be bypassed. The bypassed unit is therefore skipped, and its function is deactivated in this case. This has the advantage that not all of the functions performed by the applicable unit need to be performed at the same time. For example, the distortion unit is thus bypassed if the mirror unit requires no distortion, for example because it has an even mirror surface. The signals applied to the input of the distortion unit are then forwarded directly, without processing, to the output of the distortion unit. The same applies if no gamma correction or no dithering is desired.

A method according to the disclosure for operating a head-up display has the following steps: an image signal is generated that includes the color and/or brightness information to be displayed per pixel to be depicted. Configuration information that conforms to the head-up display and/or the current operating situation thereof is generated. Color and/or brightness information that is irrelevant to the head-up display in the current operating situation is replaced in the image signal by configuration information. The image and configuration signal thus obtained is transmitted. These steps are performed in an image signal source of the head-up display. They have the advantage that irrelevant areas of the image signal are used for transmitting configuration information. The configuration information conforms to the head-up display to be operated, for example the two-dimensional curvature of the mirror element of the head-up display is taken into consideration, the installation position of the head-up display in the vehicle or other definite but vehicle-specific properties. The configuration information is alternatively or additionally customizable to the current operating situation, for example to the ambient brightness for adjusting the brightness of the display unit, to the eye position of the viewer or to other properties that can change during operation. If the method according to the disclosure is used, fewer data lines are required in the head-up display. In addition, precise synchronization between image data and configuration information is made possible, since the two are transmitted in the same signal. The transmission is made to an image distorter or generally to an image preprocessing means.

A further method according to the disclosure for operating a head-up display has the following steps: an image and configuration information signal is received. The configuration information is separated from the image information, the color and/or brightness information. The color and/or brightness information is altered on the basis of the configuration information. The alteration is a distortion, a gamma correction, the application of dithering, or other, for example. The altered image information is subsequently transmitted. This has the advantage that configuration information appropriate to the image information is always currently on hand, and no additional data channels are required therefor.

The configuration information advantageously includes distortion information and/or interpolation information and/or information pertaining to gamma correction and/or dithering information. This has the advantages cited above in regard to the device claims.

In an embodiment, there is provision for at least some of the configuration information to be buffer-stored. This has the advantage that the buffer-stored configuration information is also available for the next frame to be displayed if said frame includes no corresponding configuration information, for example. This is the case, for example, if the configuration information does not differ from one to the next frame. However, this is also the case if the transmitted configuration information has been identified as erroneous or as possibly erroneous. Only the currently required information is buffer-stored, rather than all the possible configuration information. There are thus warping matrixes for each different position of the display cast onto the mirror unit with regard to the head height of the viewer and his lateral seat position. These warping matrixes are stored in a memory unit that the image signal source accesses, and the image distorter need only provide a low storage capacity.

Advantageously, no image information but rather only configuration information is transmitted or received in a starting phase of the method. This has the advantage that the setup of a stable data connection and the configuration of the image distorter are effected without color and/or brightness information being on hand. If these were to be displayed while the operating situation were not yet stable, the display of incomplete or random and hence potentially irritating depictions on the display unit could lead to irritations for the viewer. This is prevented by the measure according to the disclosure.

In an embodiment, there is provision for the current position of the eyes of a viewer to be detected and for the detected position to be used for the configuration information. This has the advantage that the distortion compensation is optimally customized to the respective current area of the mirror element for combining, and hence an image that is as distortion-free as possible is obtained even when the head or eye position of the viewer is frequently altered. In the head-up display, means for detecting the position of the head or, better still, the position of the eyes of the viewer are on hand for this purpose. The position thus means the level of the eyes and the lateral offset thereof relative to the applicable axis of the head-up display. To this end, a camera is arranged in the interior of the vehicle, for example. Alternatively, other adjusting means, such as a joystick, a slide control or the like, which the viewer can use to manually input or adjust his position, can advantageously be used in this case. The detected position is processed by evaluation means for selecting the suitable warping matrix attuned to the current position.

An image signal according to the disclosure for a head-up display has control signals, color and/or brightness information and configuration information, wherein the configuration information is included in areas of the color and/or brightness information that include irrelevant color and/or brightness information. Irrelevant color and/or brightness information is completely black areas, for example, which, as a characteristic of head-up displays, take up relatively large areas of the display. For display on a display unit, the configuration information is removed and the applicable image information is set to “black”. The signal according to the disclosure has the advantage that a known data format is extended and hence is used for transmitting configuration information, which relates specifically to the permanent properties of the head-up display and the current operating situation thereof. No disruptive time offset arises that can be avoided only with difficulty when configuration information and image information is transmitted separately. Very fast adaptation to changing warping requirements is therefore made possible.

In an embodiment, there is provision for the configuration information to be arranged in the middle two or four bits of a byte provided for color and/or brightness information. This has the advantage that regardless of whether a signal having eight, seven, six or five bits is transmitted in the byte provided for the image information, and regardless of whether the signals having fewer than 8 bits are arranged at the MSB or LSB end of the byte, the configuration information is at any rate at the location where image information can normally be expected. When the configuration information is separated from the image information, the color and/or brightness information, there is thus no need to distinguish between different bit lengths of the image information.

If the head-up display is used to display vehicle information such as speed, high beam switched on, navigation information or the like, which is usually also displayed in a combination instrument of a motor vehicle, then the image distorter is typically part of the combination instrument. In this respect, the term head-up display used here relates not only to the pure optics and mechanics and the direct electrical actuation thereof but also to certain signal processing elements and steps that are outside the pure optics and mechanics of the head-up display. The present disclosure can be usefully used not only for head-up displays that make vehicle information available to the driver via the windshield or a combiner, but also for other display systems in which image distortion is used. Examples of these are rear seat entertainment or projection systems that use the rear surface of the driver's or passenger's seat as a projection surface, or corresponding systems that use the side windows or other curved surfaces as projection surfaces.

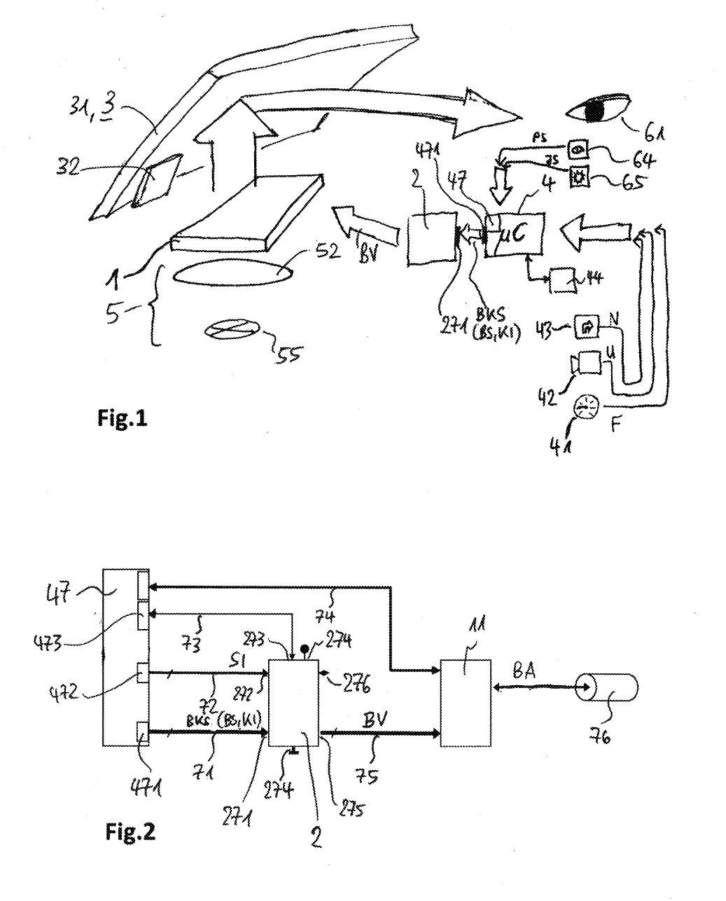

FIG. 1 shows an exemplary head-up display according to the disclosure. A display unit 1 is actuated by an image distorter 2. Said display unit imprints the image displayed on it onto the light that passes through it from a light source 5 and is directed into the eye 61 of a viewer by a mirror unit 3. The mirror unit 3 in this case is in the form of a windshield 31. It may alternatively be a combiner 32, depicted by way of example in this case that is arranged between the display unit 1 and the windshield 31. The light source 5 in this case consists of an illuminant 55 and a lens 52. The illuminant provided may be a halogen lamp, a light emitting diode or another suitable illuminant. The image distorter 2 receives an image signal BS from an image signal source 47 that is part of a control unit 4. The control unit 4 is connected to a memory 44 for distortion data, the warping matrixes W.

In the example depicted, the image signal BS has vehicle state information F, surroundings information U and navigation information N. The vehicle state information F comes, by way of example, from a speedometer 41 that is indicated in this case. The surroundings information U comes from a camera 42 that is indicated in this case, and the navigation information N comes from a navigation appliance 43 that is indicated in this case. Said information is supplied to the control unit 4 and processed thereby.

A position sensor 64 detects the position of the eyes 61 of the viewer, who may be either the vehicle driver or another viewer. The detected position signal PS is forwarded to the control unit 4. An adjusting element 65 allows manual adjustment of the position of the viewer, either instead of using a position sensor 64 or as a supplement thereto, for example to take into consideration a different eye spacing for each viewer. The adjusting element 64 may be either a physical adjusting element, such as a rotary knob or slide control, or an element that is displayable and operable on a touchscreen, for example. The detected adjusting signal JS is likewise routed to the control unit 4. The latter takes into consideration the position signal PS and the adjusting signal JS in order to take configuration information KI from the memory 44. Said configuration information corresponds to that area of the windshield 31 at which the light entering the eye 61 of the viewer is reflected, which area results from the position of the eye 61 of the viewer. The control unit 4 combines this configuration information KI with the image signal BS and routes the combined image and configuration signal BKS via a common output 471 to a common input 271 of the image distorter 2. The image distorter 2 processes the image signal BS in accordance with the configuration information KI, which includes, inter alia, information relating to image distortion, for example a warping matrix, and forwards a distorted image signal BV to the display unit 1.

FIG. 2 shows a circuit arrangement according to the disclosure. It is possible to identify the image signal source 47, the output 471 of which is connected to the input 271 of the image distorter 2 via the line 71. The line 71 is used for parallel data transmission of the combined image and configuration signal BKS and has a width of 28 bits in the exemplary embodiment. Control information SI is routed via a line 72 having a width of two bits from an output 472 of the image signal source 47 to an input 272 of the image distorter 2. An Enable/Reset port 473 is connected via a serial line 73 to an applicable input 273 of the image distorter 2.

The image signal source 47 is connected via a bidirectional line 74 to a signal processor 11 that receives, via a line 75 for parallel data transmission having a width of 28 bits, the image signal BV processed by the image distorter 2 and output at the output 275. The signal processor 2 converts the digital image signal BV into an image signal BA customized for the display unit 1, which image signal is transmitted via a protected line 76 to the display unit 1. The image distorter 2 has ports 274 for the supply of power, and further ports 276, which are not described in detail at this juncture.

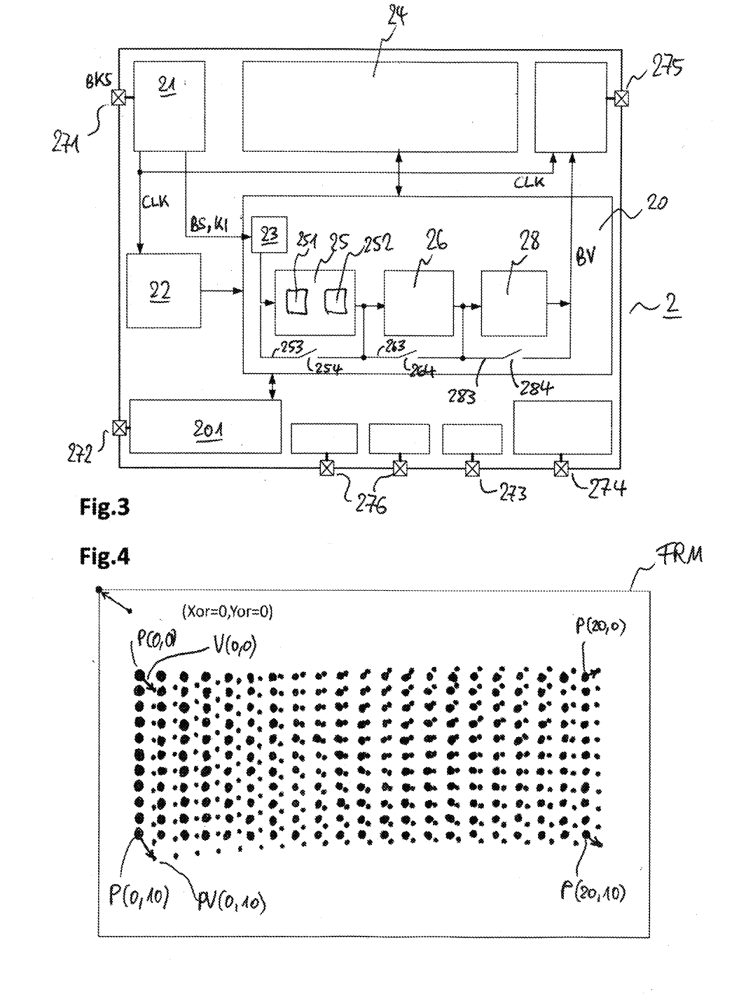

FIG. 3 shows an image distorter 2 according to the disclosure. The combined image and configuration signal BKS arrives at a handling stage 21 via the input 271. The handling stage detaches a piece of clock information CLK and forwards it to a clock generator 22. Said clock generator generates and monitors a clock for the subsequent units of a logic unit 20. The logic unit 20 has an error correction unit 23 that checks and, if need be, corrects image signal BS, configuration information KI and possibly further parts of the combined input signal BKS for errors. To this end, a cyclic redundancy check, known by the name CRC, is performed, for example. Other known methods for determining and correcting errors that can arise during the transmission of data can also usefully be used in this case. The logic unit 20 identifies whether the input data are image signal information that is forwarded to the subsequent units as input data, or configuration information KI that is either forwarded to the subsequent units as configuration data or stored in a memory 24.

The logic unit 20 has a warping unit 25, a gamma correction unit 26 and a dithering unit 28. The warping unit 25 has a distortion unit 251 and an interpolation unit 252. The warping unit 25 can be bypassed by means of a bypass 253, depicted schematically by means of a switch 254 in this case. When it is bypassed, no warping takes place, and the input signal is forwarded directly to the subsequent units the gamma correction unit 26 and/or the dithering unit 28. Corresponding bypasses 263, 283 and switches 264, 284 also exist for the gamma correction unit 26 and the dithering unit 28. The processed image signal BV is output together with the clock signal CLK at the output 275.

The supply of power is provided via the port 274, and Enable/Reset via the input 273. Control signals are accepted by the input 272 and processed in a control unit 201 that communicates with the logic unit 20. The further ports 276 are not described in more detail at this juncture.

FIG. 4 shows an example of image distortion. It depicts an image frame FRM, also called a frame, whose origin (Xor=0, Yor=0) is in the top left corner. The image points P(n,m) to be depicted, where n=0, . . . , 20 and m=0, . . . , 10, are arranged as bold black dots in a regular grid. The image points PV(n,m) displaced by the image distorter 2 after distortion are depicted as small dots. They are computed from the image points P(n,m) by displacement through the vectors V(n,m). The vectors V(n,m) transmitted as part of the configuration information KI form a warping matrix W. It is possible to identify that the displacement vectors V(n,m) have different directions and magnitudes. This is down to the fact that the mirror unit 3 has an inconsistent curvature that is compensated for by the distortion by means of the warping matrix W. The pixels in the original image are then inside the axially parallel rectangles, and the target pixels are in what is known as a quad (quadrangle) that is determined by the respective warping matrix (or displacement vectors) and whose interpolation points are represented by the smaller dots.

It is additionally possible to identify that the image frame FRM has no pixels P(n,m) to be depicted in the upper and lower areas. The reason for this, inter alia, is that the image width for the head-up display is substantially greater than the image height, while the usual structure of the image data, which is known from the sphere of television, has a greater height in proportion to the image width. In the upper and the lower areas of the image frame FRM that are not used for image points P(n,m), configuration information KI, for example the warping matrix W, is transmitted according to the disclosure.

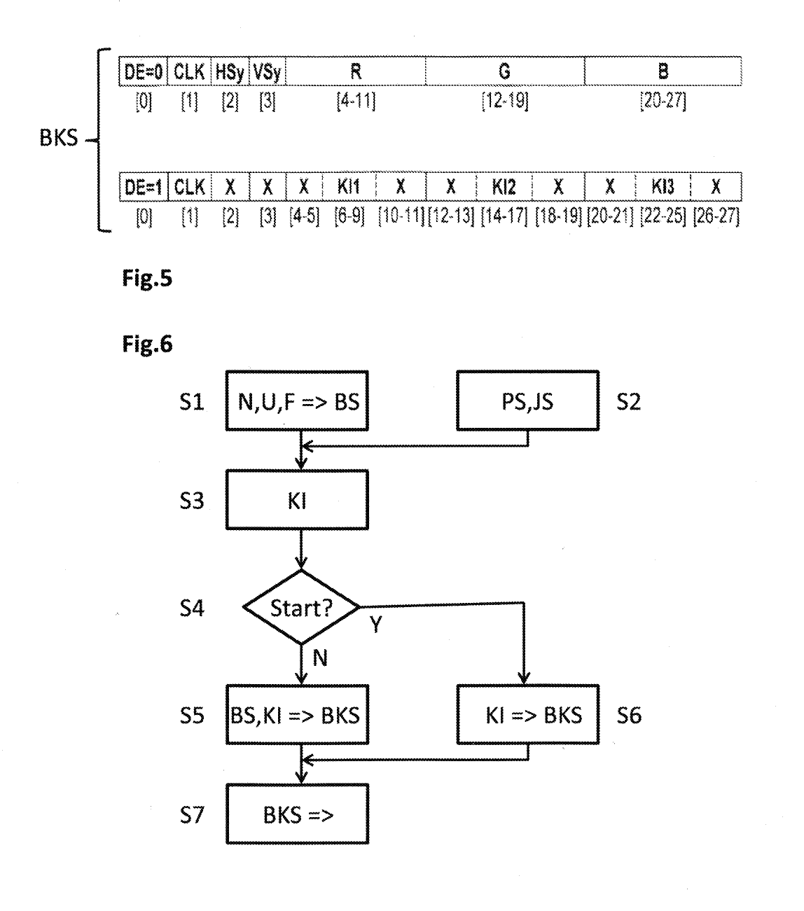

FIG. 5 shows a signal BKS according to the disclosure, combined from image signal BS and configuration information KI. In the upper row, it is possible to identify the data structure that applies to the rows of the image frame FRM that include image information. The first bit [0] includes a Data Enable signal DE, which has the value “0” if the subsequent data are image information. There follow a clock signal CLK, a horizontal synchronization signal HSy and a vertical synchronization signal VSy. These each have a width of 1 bit. There follow color and brightness data R for red, G for green and B for blue in the RGB format, each with a width of 8 bits. Instead of the RGB format, it is also possible for other formats to be used in this case that transmit the applicable image information.

In the lower row, it is possible to identify the data structure that is intended for the rows of the image frame FRM that include no or irrelevant image information. In this case, the Data Enable signal DE has the value “1”, which indicates that the subsequent data are configuration information KI. In this case, no synchronization signals HSy, VSy are transmitted, and the bits [2] and [3] have no defined value, depicted in this case by X. The configuration information KI1, KI2, KI3 is transmitted only in the middle four bits of the respective color components R, G, B in this case. The other bits have no defined value, depicted in this case by X.

The middle bits of the color components R, G, B, in this case the bits [6-9], [14-17] and [22-25] of the combined image and configuration signal BKS, can also be referred to as bits numbers 2-5 of a byte that is consecutively numbered starting at bit 0. This is the case, for example, if the color components R, G, B are regarded as a respective byte, independently of the other bits of the data structure of the signal BKS. Regardless of whether, in an instance of application, one or more of the lower two bits numbers 0 and 1 and/or of the upper two bits numbers 6 and 7, or none of these bits, is omitted, the communication interface according to the disclosure can be used unchanged.

FIG. 6 shows a flowchart for a method according to the disclosure for operating a head-up display. This method is usually performed in the image signal source 47. In a step S1, an image signal BS is generated from navigation information N, surroundings information U and vehicle information F. In this case, the image signal BS has color information and/or brightness information per pixel of the image to be displayed. In step S2, the current position PS of the eyes of a viewer is detected, and, alternatively or additionally, an adjusting signal JS is generated. In step S3, configuration information KI is generated that is customized to the head-up display and/or the current operating situation thereof. According to one variant, this is accomplished using the position signal PS and/or the adjusting signal JS, this not being the case according to another variant.

According to an aspect, a distinction is drawn in step S4 as to whether or not the image distorter 2 is in a starting phase. If it is in a starting phase, only the configuration information is used to generate the combined image and configuration signal BKS in step S6. Alternatively, or if the starting phase is over, both the image signal BS and the configuration information KI are used in step S5 to generate the combined image and configuration signal BKS. This signal is transmitted in step S7.

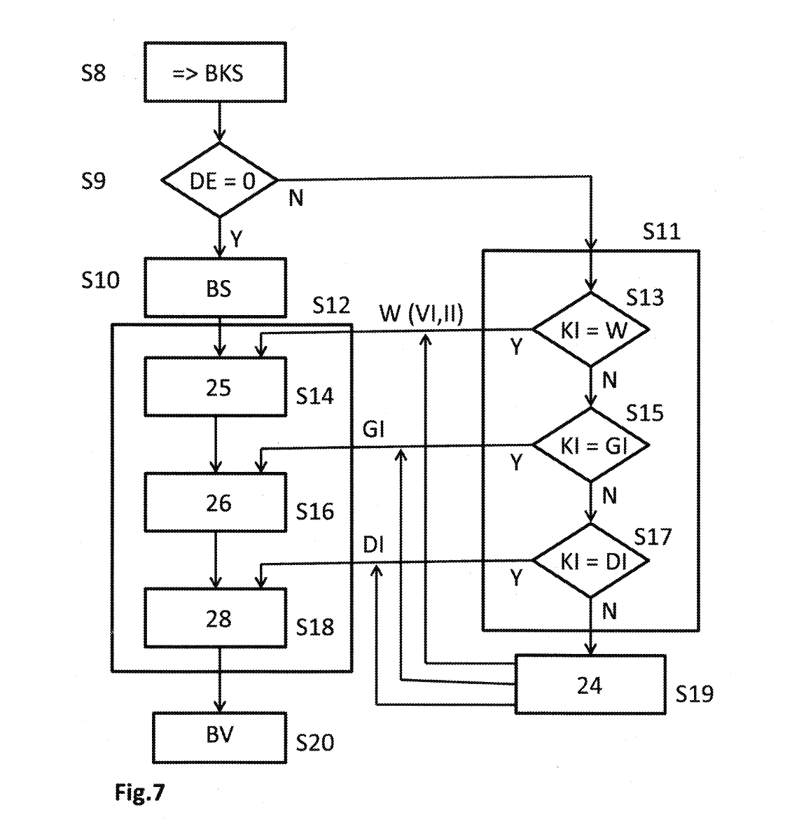

FIG. 7 shows a flowchart for a method according to the disclosure for operating a head-up display. The method shown in this case is usually performed in the image distorter 2. In step S8, a combined image and configuration signal BKS is received. On the basis of the value of the Data Enable signal DE, either the data R, G, B of the image signal BS is forwarded to step S10 or the configuration information KI is forwarded to step S11. In step S11, the configuration information is, if need be, split into the warping matrix W, the gamma correction information GI, the dithering information DI and possibly further information. These are buffer-stored if need be and forwarded to step S12. In step S12, the image signal BS is processed on the basis of the configuration information KI received from step S11 and is subsequently output as processed image signal BV in step S20.

If the configuration information KI is the warping matrix W, then this is forwarded to step S14 in step S13. In step S14, the warping unit 25 performs distortion of the image signal BS on the basis of the warping matrix W. If the configuration information KI is gamma correction information GI, then this is forwarded to step S16 in step S15. In step S16, the gamma correction unit 26 performs gamma correction for the image signal BS, in this case the already distorted image signal. If the configuration information KI is dithering information DI, then this is forwarded to step S18 in step S17. In step S18, a dithering unit 28 performs dithering for the already preprocessed image signal BS. If the configuration information KI is none of the expected information, then it is assumed either that the configuration information does not differ from that pertaining to the preceding image frame FRM or that the currently received configuration information is erroneous. In both cases, step S19 involves resorting to the preceding configuration information KI stored in the memory 24, to the warping matrix W, gamma correction information GI, dithering information DI and possibly further information, and this is forwarded to the respective steps in step S12. Therefore, in step S12, the color and/or brightness information of the image signal BS is altered, and subsequently the altered image signal BV is transmitted. The transmission is made to the display unit 1. In this case, it is assumed that the warping matrix W includes not only the distortion information VI but also interpolation information II.

The configuration information KI is generally delivered before the image information, that is to say in an image frame FRM that precedes the image frame FRM including the image information. In this case, each image frame FRM can include configuration information KI, but does not have to. Configuration information KI, once transmitted, then also applies to the image data of subsequent image frames FRM. The configuration information KI is thus normally not used for the current image frame FRM. It is transmitted to internal memories that are double-buffered, so that the configuration information KI available in the other memory is always correct, since it is used for image alteration, and incompletely or erroneously transmitted configuration information KI would lead to incorrect image alteration. Only if the currently delivered configuration information KI is correct is the depiction of the current image frame FRM followed by a buffer changeover being performed, for example in the case of the image change/flip, which means that the freshly received configuration information KI becomes configuration information KI to be used at present that alters the next images to be depicted accordingly.

The disclosure thus relates to the embedding of configuration and warping data into what is known as the porch of the actual image data. The porch either just contains image information for “black”, that is to say image information that is not depicted, or is used in newer display units 1 for equalizing the charge conditions in the glass of the display. Besides the actual image data, the porch is transmitted via the image data interface. In an embodiment, configuration data, among other things the warping matrix W, are inserted into the area of the porch and hidden again before output to the display unit.

In specific terms, at the beginning of the porch the GPU, the image signal source 47, inserts a data block with the configuration data and the warping matrix into the image data stream, which is then locally buffer-stored, and used, in the image distorter 2 to implement the warping. Before the “warped” image data are output to the display unit 1 or the signal processor 11, which can also be used as a “serializer” for remote systems, the inserted data of the combined image and configuration signal BKS are then hidden again. This process is repeated with every frame.

In order to ensure safe start-up of the warping function, the image distorter 2, which is realized as a separate integrated circuit in the exemplary embodiment, is used to perform the following handshake method:

start up the image distorter 2 by applying the required supply voltage to the ports 274, if need be including a clock signal.
Start the output of the clock signal CLK with blank image content, what is known as a black image, but with configuration information KI, including the warping matrix W, via the line 71.
On successful reception of the configuration information KI, particularly the warping matrix W, and if the image distorter 2 is fully operational, an external pin, the port 273, is used to confirm that the image distorter 2 is ready for operation to the image signal source 47.
Using the Data Enable signal DE in the signal BKS or using a further pin, not described in more detail at this juncture, or using the control information SI, the image signal source 47 signals to the image distorter 2 to apply the warping function to the incoming image signals R, G, B, and to start the output of the processed image signal BV.

Advantages of the solution according to the disclosure are, inter alia, the relief of the load on the image signal source 47 in terms of graphics performance and computation power, the shortening of the startup time, since the transmission of the configuration information KI is effected much more quickly than by serial transmission, minimization of the number of ports, what are known as pins, required for the image distorter, since no additional serial or parallel interfaces are required, and scalability of the overall system, since the same image distorter 2 can also be used to realize variants having lower color resolution, for example six instead of eight bits per image signal R, G, B, or, if the image distorter is dispensed with, the image signal source 47 can also be used for vehicles without a head-up display without having incorporated the—in these cases superfluous—scope of functions of the image distortion.

The measures cited in the individual exemplary embodiments and in the introductory part of the description can also be usefully used in combinations other than those depicted without departing from the scope or spirit of the disclosure.

1. A head-up display with image distortion for a vehicle, comprising:
an image signal source, the image signal source comprising a common output for image signals and configuration information,
an image distorter, the image distorter comprising a common input for image signals and configuration information,
a display unit, and
a mirror unit.

2. The head-up display as claimed in claim 1, wherein the image distorter comprises at least one of a distortion unit, an interpolation unit, a memory unit, a gamma correction unit and a dithering unit.

3. The head-up display as claimed in claim 2, further comprising a bypass.

4. The head-up display as claimed in claim 1, wherein the head-up display if further configured to detect a current position of eyes of a viewer and to generate configuration information based at least in part on the detected position of the eyes.

5. A method for operating a head-up display, comprising the steps:
generating an image signal with at least one of color and brightness information to be displayed per pixel,
generating configuration information customized to at least one of the head-up display and operating situation thereof,
replacing at least one of color and brightness information that is irrelevant to the head-up display in the current operating situation with configuration information, and
transmitting the image and configuration signal obtained in this manner.

6. The method as claimed in claim 5, wherein the configuration information comprises at least one of distortion information, interpolation information, gamma correction information and dithering information.

7. The method as claimed in claim 6, wherein at least some of the configuration information is buffer-stored.

8. The method as claimed in claim 7, wherein at least one of color and brightness information is not transmitted in a starting phase of the method.

9. The method as claimed in claim 5, further comprising:
detecting a current position of eyes of a viewer, and
generating configuration information based at least in part on the detected position.

10. A method for operating a head-up display, comprising the steps of:
receiving an image and configuration signal,
separating configuration information from at least one of color and brightness information,
altering the at least one of color and brightness information on the basis of the configuration information, and
transmitting the altered at least one of color and brightness information as a processed image signal.

11. The method as claimed in claim 10, wherein the configuration information comprises at least one of distortion information, interpolation information, gamma correction information and dithering information.

12. The method as claimed in claim 11, further comprising buffer-storing least some of the configuration information.

13. The method as claimed in claim 12, wherein at least one of color and brightness information is at least one of not transmitted and not received in a starting phase of the method.

14. The method as claimed in claim 10, further comprising:
detecting a current position of eyes of a viewer, and
generating configuration information based at least in part on the detected position.
